(19) United States
(12) Patent Application Publication
(10) Pub. No.: US 2012/0258428 A1
(43) Pub. Date: Oct. 11, 2012

(54) MODULATING LASER FOCAL LENGTH TO OPTIMIZE SURFACE TEXTURING ON MULTIPLE SURFACES

(76) Inventor: Fred J. MOLZ, Birmingham, AL (US)

(21) Appl. No.: 13/441,461

(22) Filed: Apr. 6, 2012

Related U.S. Application Data
(60) Provisional application No. 61/473,284, filed on Apr. 8, 2011.

(51) Int. Cl. A61C 8/00; A61C 13/00; B29B 13/08

(52) U.S. Cl. 433/174; 425/174.4; 264/16

(57) ABSTRACT

A system and method for applying a uniform micro-textured surface treatment to a deep-thread dental implant by rapidly modulating the focal point of a laser to laser etch surfaces of both the thread peaks and the thread valleys in a single pass.

### CROSS-REFERENCE TO RELATED APPLICATION

This application claims the benefit of U.S. Provisional Patent Application Ser. No. 61/473,284, filed Apr. 8, 2011, the entirety of which is hereby incorporated herein by reference for all purposes.

### TECHNICAL FIELD

The present invention relates generally to the field of material processing, and more particularly to systems and methods of applying a micro-textured surface on a product having a segmented or irregular macro surface depth profile by modulating or controlling the focal point of a laser used to laser-etch the surface.

### BACKGROUND

Application of a micro-textured surface treatment to a product may be carried out by laser etching, for example in the application of a micro-texture surface to biomedical or dental implants for improved tissue growth. U.S. Pat. Nos. 5,322,988; 5,607,607; 5,645,740; 6,068,480; 6,299,429; 6,419,491 and 6,454,569, and U.S. Patent App. Pub. No. US2005/0211680A1 are incorporated herein by reference.

Currently known surface treatment techniques use a laser with a constant focal length to texture or treat the surface of a rotating implant. This process produces acceptable results when the lased surface is positioned a relatively constant distance from the laser source, producing a relatively uniform texturing over the entire treated surface. However, if the distance of the lased surface from the laser varies by a significant amount (for example 0.015″ or more), the laser may not focus correctly on some, or all, of the surface, and may fail to create a uniform surface texture.

For example, in a deep-thread dental implant having a thread depth of greater than 0.015″, the thread crest surfaces (at the major diameter of the threaded portion) are positioned significantly closer to the laser than the thread valley surfaces (at the minor diameter of the threaded portion). Surface treatment with a laser focused at the major diameter will not produce the desired uniform texturing at the minor diameter, whereas treatment with a laser focused at the minor diameter will not produce the desired uniform texturing at the major diameter, and treatment with a laser focused at some depth between the major and minor diameters may not produce the desired uniform texturing at either.

Attempts to treat deep-threaded implant surfaces in two passes, one focused at the minor diameter and the other at the major diameter, have not proven successful, as the second pass washes out the surface texture created by the first pass. This has been shown to result regardless of which surface is lased first.

Accordingly, it can be seen that needs exist for improved systems and methods of surface treatment of objects having a segmented or irregular depth profile. It is to the provision of improved systems and methods meeting these and other needs that the present invention is primarily directed.

### SUMMARY

In example embodiments, the present invention provides improved systems and methods of surface treatment of objects having a segmented or irregular depth profile. In example embodiments, the major and minor diameter surfaces of a deep-thread dental implant are treated to generate a highly segmented, uniform micro-textured pattern for improved tissue growth, using rapid modulation or adjustment of the laser focal point or focal depth timed in coordination with the rotation of the implant.

In one aspect, the present invention relates to a system for treating the surface of an object. The object includes at least first and second surface segments with a varying depth between the first and second surface segments. The system includes a laser for applying a uniform surface treatment to both the first and second surface segments of the object. The system also includes an optics system for directing the laser with respect to the object and a focus control mechanism for modulating the focal point of the laser with respect to the object surface.

In another aspect, the invention relates to a method of treating a surface of an object with at least first and second surface segments and a varying depth between the first and second surface segments. The method includes applying a uniform surface treatment to both the first and second surface segments in a single operation. The method also includes modulating the focal length of the uniform surface treatment with a focus control mechanism.

In still another aspect, the invention relates to a system for treating the surface of an object having an irregular surface. The system includes a sensor for mapping the object irregular surface to obtain control data. The system also includes a laser for applying a surface treatment defined by the control data and an optics system for directing the laser with respect to the object. The system further includes a focus control mechanism for modulating the focal point of the laser with respect to the object surface.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a side view of a dental implant for surface treatment according to an example embodiment of the present invention.

FIG. 2A-2B show the dental implant of FIG. 1 in cooperation with, and separated from, a mandrel.

FIG. 3 schematically shows the processing setup used for excimer laser-assisted etching.

FIG. 4 is a schematic block diagram illustrating an assemblage that can be used in the system of the invention;

FIGS. 5A-5B show an example irregularly-shaped abutment from different angles.

FIGS. 6A-6C shows a front view of an example tooth anatomy.

FIG. 6B shows a side view of the tooth shown in FIG. 6A as viewed along B-B.

FIG. 6C shows a cross-sectional view of the tooth shown in FIG. 6A as viewed along C-C.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

In an example embodiment of the invention, a system and assemblage produce surface treatments for medical and dental implants and substrates, or abutments with irregular surfaces, by employing a high energy source to ablate the surfaces of the implants, abutments and substrates. The example system includes a mandrel, a rotationally driven fixture, a laser, and a focus-control mechanism to carry out a surface treatment method on a medical or dental implant, substrate or abutment.

In an example operation, an untreated implant is mounted into a mandrel. The surface of the implant can have a pattern with crests having a major diameter D₁ and valleys having minor diameter D₂, for example a helical threading pattern. The mandrel is rotationally driven by a fixture to rotate the implant about its central lengthwise, or longitudinal, axis. At least a portion of the implant surface treatment zone is formed by scanning a laser across a lengthwise band or section of the implant as the implant is rotated a single revolution.

A focus-control mechanism rapidly adjusts the laser focal length in timed coordination with the rotation of the implant, focusing the laser at the depth of the point on the surface being treated. Thus, when the laser is treating the thread crests, the laser has a first focal length F₁ corresponding to the major diameter D₁; and when the laser is treating the thread valleys, the laser has a second focal length F₂ corresponding to the minor diameter D₂.

In various example forms, the focus-control mechanism can include a rapid switching mechanism for varying the focal distance of the laser, a lens switching or refocusing mechanism, a movable stage for shifting the relative positions of the implant and the laser, and/or other means of rapidly switching the focal point of the laser in coordination with the movement of the implant. For example, one or more sensors (e.g., Rotational Variable Displacement Transducer RVDT, or stepper motor) indicating the rotational position of the mandrel and/or the fixture communicate signals to a microprocessor based computer control system, which in turn controls actuation of the focus control mechanism according to a programmed sequence of operation.

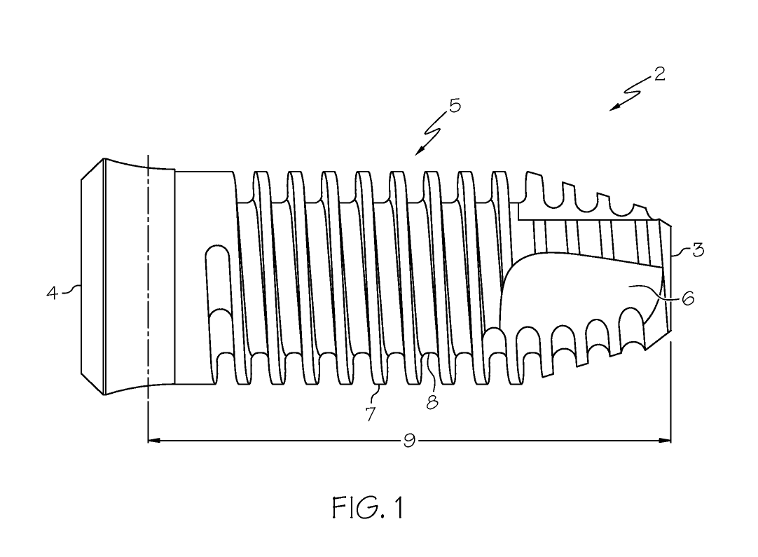

With reference now to the drawing figure, FIG. 1 shows an example deep-thread dental implant 2 having a distal end 3 and a proximal end 4. A threaded portion 5 extends from the distal end 3 toward the proximal end 4 for at least a portion of the length of the implant 2. The distal end 3 is optionally tapered to have a reduced nominal diameter relative to the remainder of the threaded portion 5, and one or more self-tapping flutes 6 machined thereon. The proximal end 4 optionally comprises one or more coupling features for attachment of a dental abutment or other prosthesis thereon.

The threaded portion 5 of the implant 2 comprises one or more helical grooves or threads, defining the major diameter D₁ at the crests 7 of the threads and the minor diameter D₂ at the valleys 8 of the threads. A thread depth of, for example, about 0.015″ or greater is defined as the distance (measured perpendicular to the lengthwise axis of the implant) between the crest 7 and the valley, or alternatively as one-half the difference between the major diameter and the minor diameter: 0.5*(D₁−D₂).

A uniform micro-textured surface treatment is applied to the surface of the depicted implant along both the major diameter (on the thread crests 7) and the minor diameter (in the thread valleys 8). For example, a pattern of 8 micron grooves can be laser etched along at least a portion of the length of the implant 2. In example embodiments, the surface treatment is applied to a zone 9 of the implant extending along all or a substantial portion of the threaded portion 5, and optionally at least a portion of the unthreaded portion toward the proximal end 4 of the implant.

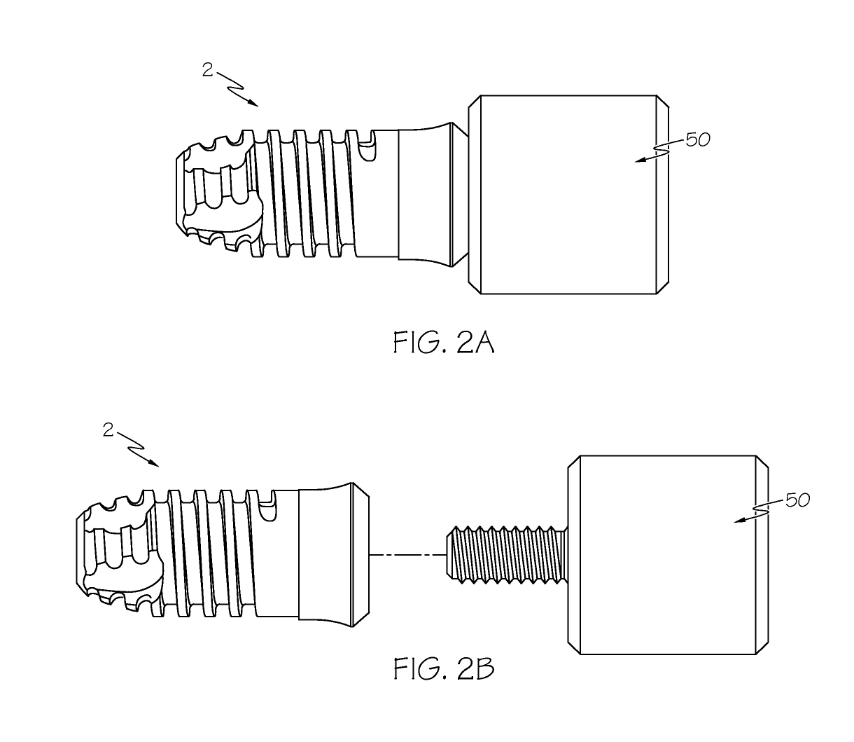

As depicted in FIGS. 2A-2B, the implant 2 can be removably secured to an attachment mechanism of a mandrel 50. An example attachment mechanism can include a male threaded surface that corresponds with a threaded female surface within the implant 2.

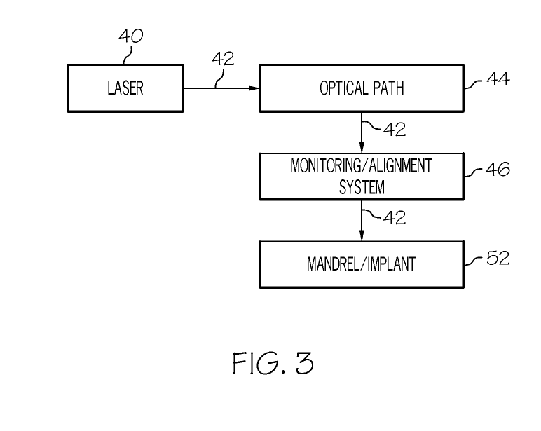

Referring now to the high-level schematic depicted in FIG. 3, a laser 40 emits a beam 42 through an optical path system 44. The optical path system 44 homogenizes, shapes and directs the beam onto an implant supported on a mandrel 52, for example as shown in FIGS. 1 and 2A-2B. A focus control mechanism 46, or monitoring/alignment system, is depicted to moderate the focal length of the laser 42 from the optics 44 with respect to the implant surface 52. When directing the beam 42 onto the implant as shown in FIG. 1, multiple grooves can be simultaneously created by incorporating a comb beam mask into the optics 44 to affect the beam. Alternatively, each groove can be affected individually one-at-a-time. In use, the focus control mechanism 46 causes rapid shift in the beam focal length of between about 0.01″ to about 0.02″, more preferably about 0.015,″ in order to transition between the valleys and the crests of the chosen implant surface. Surfaces necessitating a beam focal length greater than 0.02″ are also contemplated and could be completed using this system.

The focus control mechanism 46 can moderate the focal length through the optical path system 44 by rapidly adjusting the focus of the beam 42 emitted. For example, the beam 42 focus can be decreased to reduce the focal length for the D₁ crest 7 surface and then increased to enlarge the focal length for the D₂ valley 8 surface.

Alternatively, the focus control mechanism 46 can moderate the focal length through mechanical movement of the optical path system 44 with respect to the implant secured to the mandrel 52. For example, the optical path system 44 can rapidly move back and forth with respect to a laterally-stationary rotating implant and mandrel 52. Or, the rotating implant and mandrel 52 can rapidly move back and forth with respect to a laterally-stationary optical path system 44. Alternatively still, the focus control mechanism 46 can rapidly move both the optical path system 44 and the implant and mandrel 52 simultaneously with respect to each other. The described mechanical movement can be facilitated by a motorized fixture. The back and forth movement to moderate the focal length can be facilitated by a cam and follower mechanism within the motorized fixture or through the use of at least one servo motor. Alternatively, the back and forth movement to moderate the focal length can be facilitated by a radial input to focus from one point to another along the surface of the implant. Alternatively still, the focus control mechanism can modulate the focal length purely through an optical zoom focus and defocus with respect to the surface of the implant.

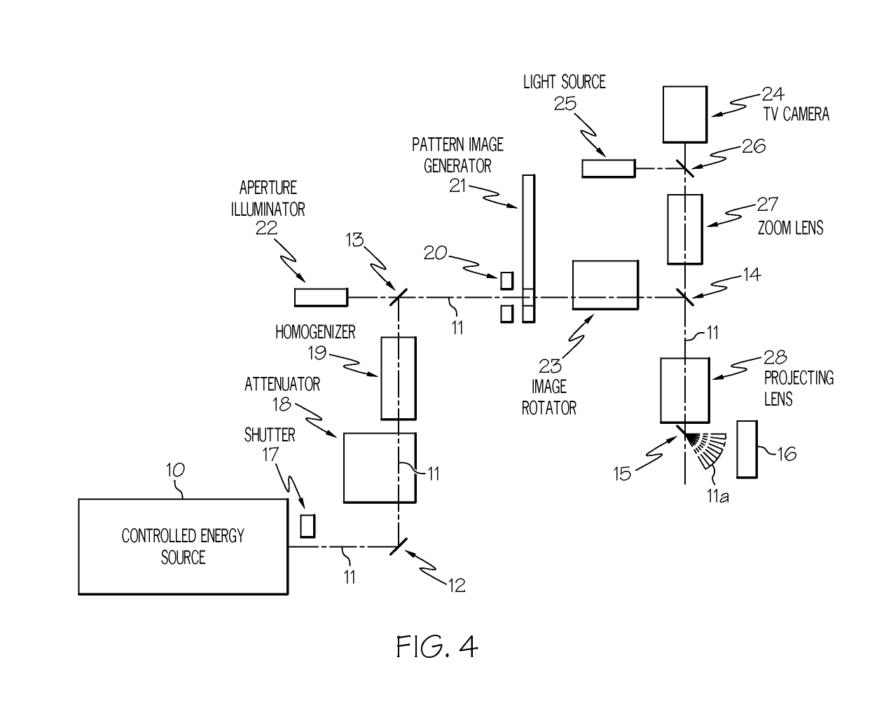

One assemblage of an optical system described in FIG. 3 that can be used in the system of the invention is illustrated in FIG. 4 wherein the source of controlled energy in the form of a radiated beam is supplied by an excimer laser 10 having a wavelength of 248 nm and whose optical beam is shown by dashed line 11. The path of beam 11 is directed and controlled by a plurality of optical mirrors 12, 13, 14 and 15. Mirror 15 directs beam 11 onto the surface of an implant or substrate 16 to create a microgeometric texturized surface of predetermined design as indicated by the plurality of beams 11 a reflected from mirror 15.

In this assemblage, a shutter 17 is positioned at the output of laser 10 to provide a safety interlock as required by the Center for Devices and Radiological Health (CDRH) and to permit the laser to be warmed up and serviced without engaging the optical beam.

Downstream from shutter 17 and mirror 12, an attenuator 18 is positioned to intercept beam 11 and control the excitation voltage of laser 10. This permits the optical power output of laser 10 to be varied without affecting the optical properties of beam 11. Preferably, attenuator 18 is a variable attenuator which enables the fluence; i.e., energy densities (measured in Joules per square centimeter, J/cm.sup.2), impacting the surfaces of the implant or substrate 16 to be varied over a range of about 10 to about 1.

From attenuator 18, laser beam 11 is preferably directed through an homogenizer 19 which serves to increase the uniformity of the intensity of laser beam 11 and maximize its usable fraction; i.e., that portion of laser beam 11 that performs its intended function which, in this instance, is ablation. Homogenizer 19 also serves to form laser beam 11 into a desired geometric shape; e.g., square, rectangular, circular, oval, elliptical, triangular, star-shaped, and the like, before it is passed through an aperture 20 to a mask carousel 21.

As beam 11 is directed through aperture 20 to mask carousel 21, an aperture illuminator 22 is engaged which enables an image having a pre-determined design or pattern to be projected onto the surface of the implant or substrate 16 in visible light before the implant or substrate surface is ablated. By passing the beam 11 through aperture 20, controlling only the desired portion of the pre-selected image projected onto the surface of the implant or substrate 16 can be effected.

Mask carousel 21 is equipped with a plurality of masks, each of which provide pre-selected line and space combinations to be imaged upon the surface of the implant or substrate 16. As the beam 11 exits mask carousel 21, it is directed through an image rotator 23 which turns the beam image being projected from the mask carousel 21 enabling any combination of lines and spaces to be imaged upon the surface of the implant or substrate 16. The image rotator 23 employed in this embodiment is a reflecting version of a Dove prism commonly referred to as a “K mirror”. It serves to rotate the image exiting mask carousel 21 about its central axis without bending or distorting its central axis permitting infinite orientation of the exiting image so that a set of predetermined lines can be ablated in any direction.

In the embodiment shown, a TV camera 24, a light source 25 illuminating the surface of the implant or substrate 16 being ablated, a splitter minor 26 for coaxial illumination, a zoom lens 27 and a projecting lens 28 are provided to enable the projected image pattern and surface of the implant or substrate 16 to be viewed in real time during ablation of the implant or substrate surface. In this embodiment, mirror 14 serves as a combiner and splitter in accepting and reflecting the imaged beam 11 from rotator 23 as well as the illumination from light source 25 and directs them through projecting lens 28 permitting the surface of the implant or substrate to be reflected and directed back through zoom lens 27 to TV camera 24 to accomplish real time ablation viewing; i.e., from about 8 to about 18 ns (nanoseconds).

Mirror 15, which directs the imaged beam 11a onto the surface of the implant or substrate 16, is movably mounted by conventional means so that it is capable of rotating and tilting to project the imaged beam 11a in any direction through from about 30 degrees to about 90 degrees relative to the longitudinal axis of the projecting lens 28. Mirror 15 is also mounted so that it can be retracted out of the path of imaged beam 11a enabling imaged beam 11a to be projected directly onto the implant or substrate surface 16. With mirror 15 movably mounted in this manner, an imaged beam can be projected to ablate the inner surfaces of U-shaped implants such as femoral components for knee replacements or the inner and/or outer surfaces of tubular or cylindrical substrates for use in promoting in vitro cell growth.

The various components comprising the assemblage described in the embodiment of FIG. 4 are commercially available. For example, excimer lasers (10) can be obtained from Lambda Physik, Lumonics, Questek and Rofin Sinar; UV grade fused silica mirrors (12, 13, 14, 15) used for excimer image beam (11) and borosilicate or crown glass used for splitter mirror (26) can be obtained from Acton Research, CVI, and Spindler and Hoyer; attenuators (18) can be obtained from Lamson Engineering; homogenizers (19) for specific applications can be obtained from the Laser Technique division of Lambda Physik; aperture illuminators (22) and illuminating light sources (25) can be obtained from Leica, Melles Griot, Nikon, Oriel and Wild; a suitable TV camera (24) can be obtained from Hitachi, Panasonic and Sony; a suitable zoom lens (27) can be obtained from Ealing, Nikon, Oriel and Sony; and, a projecting lens (28) can be obtained from Ealing and Newport; optical prisms (29) and optical mirrors (32, 33) can be obtained from Rolyn Optics Co. and Reynard Enterprises, Inc.; and, gratings can be obtained from Lasiris, Inc. These commercial sources for the various components are obviously not intended to be exhaustive, but are mentioned merely as being representative and illustrative of their commercial availability.

The assemblage of the system of the invention illustrated in FIGS. 3-4 can be readily operated using conventional computer hardware and software. A design data base can be developed for an implant or substrate from which import and export functions can be derived to convert data formats from conventional Computer Aided Design (CAD) programs. Specific microgeometric texturized design patterns and focal-length depth changes can then be prepared and programmed for operation of the assemblage components. Typically, programming of a particular design pattern will be convened into explicit commands for integrated operation of the assemblage components and control of such functions as laser voltage, laser pulse trigger, shutter speed, attenuation, aperture rotation, mask selection, image rotation, mirror tilt and rotation positioning, and the like. For example, software information required to control an optical beam and provide the measurements to texturize a particular implant surface can be generated by a “Digitizing Beam” available from Laser Design, Inc.

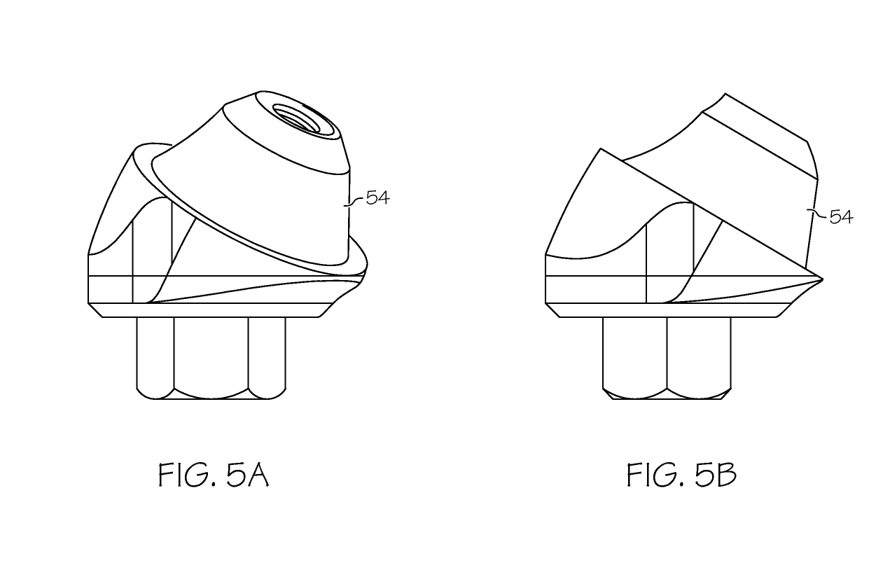

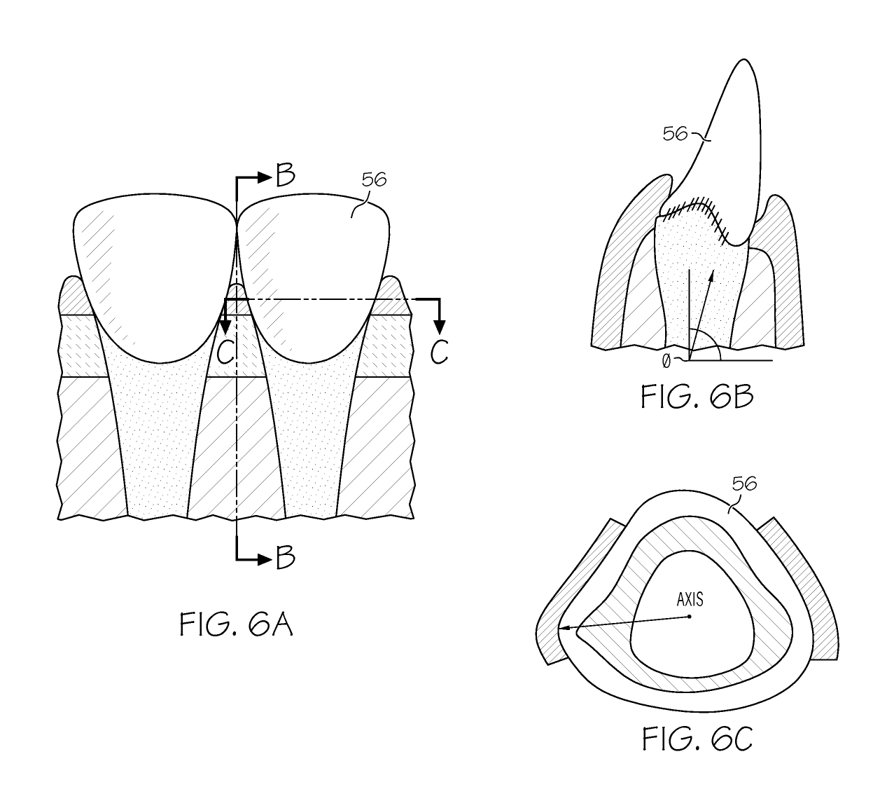

An alternative device that can be lased with a variable focal length system as described above is a custom abutment or device having an irregular and/or anatomical shape. An example irregularly-shaped abutment 54 is shown in FIGS. 5A-5B. In use, such an abutment or device is secured with respect to an implant as described in FIGS. 1-2. To demonstrate the natural anatomy that prefers such irregular shapes of abutments, FIGS. 6A-6C provide example images of a tooth 56 secured within gums. The surfaces of the example irregularly-shaped device is preferably mapped or recorded prior to completing a microtexturing process. The irregularly-shaped surface can be mapped using a laser or a coordinate measurement system. The surface mapping is preferably captured relative to an angular position of the implant to which it is be secured, so that the microtexturing focal length can be accurately calculated. This surface mapping and microtexturing can be completed by the same system.

The assemblage illustrated in FIGS. 3-4 can perform the above-described surface mapping and microtextured lasing of the above-described abutment 54. For example, an implant and the irregularly-shaped abutment or device can be mounted to a mandrel. A measuring laser and sensor or coordinate measurement system scans the device to map or define the features of its surface. The measuring laser or coordinate measurement system is preferably capable of measuring distance from a surface, for example through focal-length detection as described above. This laser preferably acquires information for any shape or surface from such distance measurement. The laser preferably also captures data relative to the angular position of the implant. The focal length data for the abutment relative to the angular position of the implant is then determined and the determined focal length data is used to control the focal point of the laser to create microtexturing on the abutment. Preferred microtexturing can include grooves having a width between about 4 microns and about 20 microns and a depth between about 4 microns and about 20 microns. Widths and depths greater than 20 microns are also contemplated and can be created by the system.

While the invention has been described with reference to preferred and example embodiments, it will be understood by those skilled in the art that a variety of modifications, additions and deletions are within the scope of the invention, as defined by the following claims.

What is claimed is:

1. A system for treating the surface of an object comprising at least first and second surface segments with a varying depth between the first and second surface segments, the system comprising:
a laser for applying a uniform surface treatment to both the first and second surface segments of the object;
an optics system for directing the laser with respect to the object; and
a focus control mechanism for modulating the focal point of the laser with respect to the object surface.

2. The system of claim 1, wherein the object is a deep-thread dental implant, the first surface segment comprising a thread crest of the implant and the second surface segment comprising a thread valley.

3. The system of claim 1, wherein the depth variation between the first and second surface segments is at least 0.015″.

4. The system of claim 1, wherein the uniform surface treatment comprises a laser-etched micro-texture pattern.

5. The system of claim 4, wherein the laser-etched micro-texture pattern comprises a width between about 4 and 20 mircons and a depth between about 4 and 20 microns.

6. The system of claim 1, further comprising a rotationally-driven carrier to rotate the object.

7. The system of claim 6, wherein the focus control mechanism modulates the focal point of the laser in coordination with the movement of the rotationally driven carrier.

8. The system of claim 1, wherein the focus control mechanism comprises a motorized platform that modulates the laser focal length with respect to the object.

9. The system of claim 1, wherein the focus control mechanism comprises an optical focus that modulates the laser focal length with respect to the object.

10. A method of treating a surface of an object comprising at least first and second surface segments with a varying depth between the first and second surface segments, the method comprising:
applying a uniform surface treatment to both the first and second surface segments in a single operation;
modulating the focal length of the uniform surface treatment with a focus control mechanism.

11. The method of claim 10, further comprising rotating the object with respect to the focus control mechanism in timed coordination with the rotation of the object.

12. The method of claim 10, wherein the focus control mechanism is a motorized platform.

13. The method of claim 10, wherein the focus control mechanism is an optical focus.

14. The method of claim 10, wherein the focus control mechanism modulates the focal length of the uniform surface treatment to correspond with the depth of the object first and second surface segments.

15. A deep-thread dental implant formed by the method of claim 10.

16. A system for treating the surface of an object comprising an irregular surface, the system comprising:
a sensor for mapping the object irregular surface to obtain control data;
a laser for applying a surface treatment defined by the control data;
an optics system for directing the laser with respect to the object; and
a focus control mechanism for modulating the focal point of the laser with respect to the object surface.

17. The system of claim 16, wherein the sensor comprises a laser for determining the control data.

18. The system of claim 16, further comprising a mandrel for supporting the object, wherein the mandrel comprises a longitudinal axis.

19. The system of claim 16, wherein the control data comprises the angular position of the object with respect to the mandrel longitudinal axis.

20. The system of claim 16, wherein the surface treatment comprises a laser-etched micro-texture pattern comprising a width between about 4 and 20 microns and a depth between about 4 and 20 microns
